(19) United States
(12) Patent Application Publication
(10) Pub. No.: US 2024/0427921 A1
(43) Pub. Date: Dec. 26, 2024

(54) SUPPLY CHAIN SECURITY MANAGER

(71) Applicant: CRYPTOGRAPHY RESEARCH, INC., San Jose, CA (US)

(72) Inventors: Matthew E. Orzen, San Francisco, CA (US); Joel Wittenauer, Pleasanton, CA (US)

(21) Appl. No.: 18/739,831

(22) Filed: Jun. 11, 2024

Related U.S. Application Data
(60) Provisional application No. 63/522,830, filed on Jun. 23, 2023.
(60) Provisional application No. 63/522,984, filed on Jun. 23, 2023.
(60) Provisional application No. 63/599,835, filed on Nov. 16, 2023.

(51) Int. Cl. G06F 21/62; G06F 21/44

(52) U.S. Cl. CPC G06F 21/6218; G06F 21/44; G06F 2221/2141

(57) ABSTRACT

A system receives, from a first provisioning entity, a request for first secure device data related to a semiconductor device. The first secure device data is associated with one or more provisioning operations performed, on the semiconductor device, by a second provisioning entity. Based on determining that the first provisioning entity has permission to access the first secure device data, the first secure device data is provided to the first provisioning entity. Second secure device data associated with one or more provisioning operations performed by the first provisioning entity on the semiconductor device is received from the first provisioning entity.

### RELATED APPLICATIONS

This application claims the benefit of U.S. Provisional Application No. 63/522,830, filed Jun. 23, 2023, and claims the benefit of U.S. Provisional Application No. 63/522,984, filed Jun. 23, 2023, and claims the benefit of U.S. Provisional Application No. 63/599,835, filed Nov. 16, 2023, the entire contents of all are incorporated by reference.

### TECHNICAL FIELD

Aspects and embodiments of the disclosure relate to cryptographic data management systems, and more specifically, to systems and methods for managing cryptographic data from multiple provisioning entities along a supply chain.

### BACKGROUND

The need for secure systems and applications is growing. Presently, allegedly secure integrated circuits (ICs) are often programmed with security keys (e.g., cryptographic keys) on the factory floors of one or more provisioning entities. Secure keys may be used in a variety of ways, such as, for example, to protect stored data, control access to digital content, or encrypt/authenticate data used in transactions. These keys may be stored in a one-time programmable memory, which may hold keys directly or hold a base key that is used with cryptographic functions that derive keys for other various functions. Typically, security is provided by performing the cryptographic key loading process in the secured facilities.

### BRIEF DESCRIPTION OF THE DRAWINGS

The present disclosure is illustrated by way of example, and not by way of limitation, in the figures of the accompanying drawings.

FIG. 1 depicts an illustrative system architecture, according to aspects of the present disclosure.

FIG. 2 depicts a flow diagram of an example method for collecting and providing secure device data to provisioning entities, according to aspects of the present disclosure.

FIG. 3 schematically illustrates example permissions metadata, according to aspects of the present disclosure.

FIG. 4 is a diagram illustrating an example of secure device data being managed along a supply chain, in accordance with some implementations of the disclosure.

FIG. 5 is a block diagram illustrating an exemplary computer system, according to aspects of the present disclosure.

### DETAILED DESCRIPTION

The embodiments described herein relate to technologies for managing cryptographic data from multiple provisioning entities along a supply chain. The following description sets forth numerous specific details, such as examples of specific systems, components, methods, and so forth, in order to provide a good understanding of several implementations of the present disclosure. It will be apparent to one skilled in the art, however, that at least some implementations of the present disclosure may be practiced without these specific details. In other instances, well-known components or methods are not described in detail or presented in simple block diagram format to avoid obscuring the present disclosure unnecessarily. Thus, the specific details set forth are merely exemplary. Implementations may vary from these exemplary details and still be contemplated to be within the scope of the present disclosure.

In general, as a semiconductor device such as a System on Chip (SoC) or a Field Programmable Gate Array (FPGA) moves through a supply chain of provisioning entities, the semiconductor device may be provisioned by each of the provisioning entities. Provisioning may refer to the process of creating and/or setting up an information technology infrastructure, and includes the operations required to manage user and system access to various resources. At each stage in the supply chain, each provisioning entity that intends to interact with the semiconductor device may desire to verify that previous provisioning entities have provisioned the semiconductor device with the correct cryptographic data (e.g., programmed the correct firmware, stored the correct cryptographic keys, etc.) and that no additional or erroneous provisioning has taken place. Additionally, consumers of the semiconductor device (once the provisioning operations are complete) may desire to verify the entire provisioning chain of events to confirm that the semiconductor device may be trusted. As individual semiconductor devices are combined into composite devices (e.g., semiconductor devices created from multiple semiconductor devices, such as a circuit board with multiple semiconductor devices), the requirements for authentication, attestation (operations taken by a processing device to provide evidence that, for example, a semiconductor device is a particular device made by a particular manufacturer, has the correct cryptographic data programmed, etc.), and final verification remains but become more complex. This is because, for each semiconductor device of a composite device, the provisioning operations from multiple provisioning entities (and possibly from external entities as well) need to be verified.

Aspects of the disclosure address at least the above challenges among others by implementing a system to collect semiconductor device information (referred to as “secure device data”) across a supply chain for use by provisioning entities during authentication and attestation operations, and to provide aggregated provenance data as evidence that a composite device and all of the semiconductor devices that make up the composite device have been processed by authorized provisioning entities of the supply chain in an approved manner. In particular, a supply chain security manager may receive and store secure device data from each provisioning entity of a supply chain. The secure device data may include secure data assets (e.g., software, codes, keys, signed certificates, and other important sensitive assets), endorsements, and/or any other type of data used for authentication, attestation, provisioning or other cryptographic operations. Endorsements may include one or more measurement values that are deemed to be allowed (e.g., satisfy a threshold criterion indicative of proving that a certain semiconductor device is a particular device, has a particular set of provisions, is from a particular manufacturer(s), etc.), where measurement values may include a signature, a hash, or any other cryptographic value that represents an object (e.g., software, firmware, etc.) or state (e.g., content of a memory device, such as, for example, of one-time programmable “OTP” memory, of non-volatile memory, a bitstream (file that contains configuration data) of a processor, etc.).

At each step (e.g., operation) along a supply chain, a provisioning entity may generate and send certain secure device data related to a semiconductor device to the supply chain security manager. As the semiconductor device moves along the supply chain to a subsequent provisioning entity, the subsequent provisioning entity may request the secure device data to verify the authenticity and state of the semiconductor device by using the secure device data to perform authentication and attestation operations. In some implementations, the supply chain security manager may provide a layer of security when managing the requests for the secure device data by determining if the requesting provisioning entity is entitled to access to the requested secure device data. For example, the supply chain security manager may perform a lookup of a metadata data structure to determine whether a particular provisioning entity is granted access to particular secure device data. By collecting secure device data (e.g., the authentication and/or attestation endorsements) as a semiconductor device moves along the supply chain and making that information available to later supply chain provisioning entities, the efficacy of authentication and attestation checks may be improved.

The supply chain security manager may further generate an authentication report that includes a recorded trail of the secure device data provided by each provisioning entity for each semiconductor device of one or more composite devices. The authentication report may be provided to an end user (e.g., a customer) to present evidence of authentication. By aggregating the secure device data into a per-device provenance chain, consumers of a composite device may evaluate the trust level of the operations that took place along the supply chain. The trust level of the final product may be quantified and compared to the trust level of products that travel through different supply chains.

As noted, a technical problem addressed by implementations of the disclosure is that verification of semiconductor devices and composite devices that travel along a supply chain of multiple provisioning entities becomes more complex since the provisioning operations of each provisioning entity for each semiconductor device of a composite device need to be verified.

A technical solution to the above identified technical problems may include implementing a supply chain security manager configured to store, for each semiconductor device and for each composite device, secure device data associated with the provisioning operations performed by each provisioning entity along a supply chain. Furthermore, the supply chain security manager also provides a level of security by managing the secure device data requests by determining if the requesting provisioning entity is entitled to access to the requested secure device data.

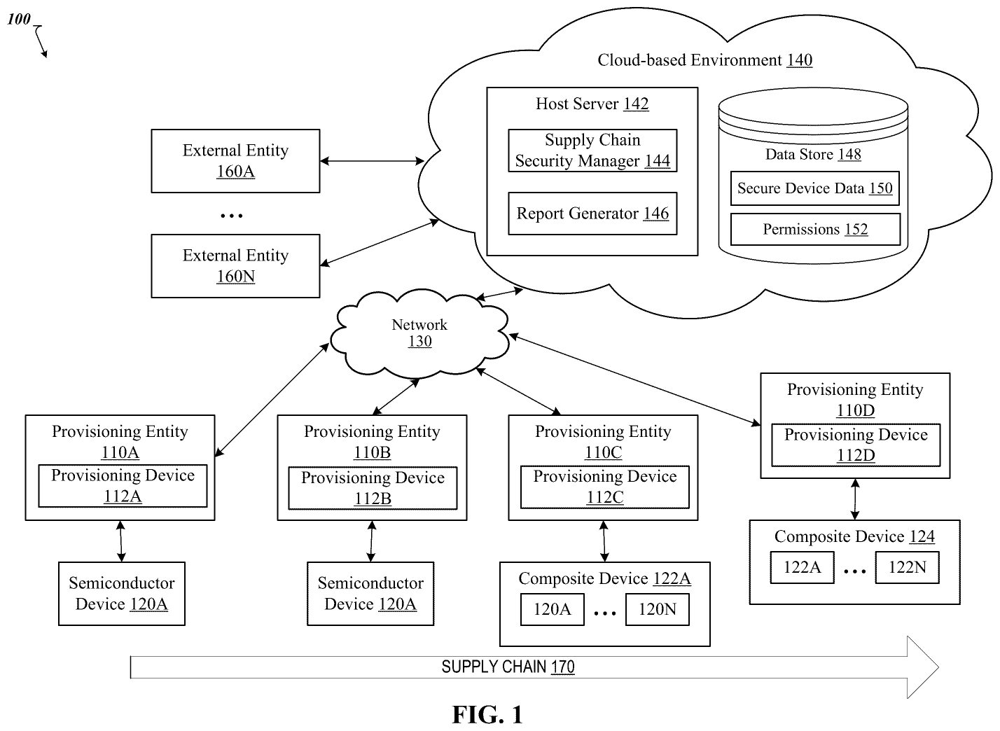

FIG. 1 depicts an illustrative system architecture 100, according to aspects of the present disclosure. Computer system architecture 100 includes provisioning entities 110A-110D (generally referred to as “provisioning entity(s) 110” herein), semiconductor devices 120A-120N (generally referred to as “semiconductor device(s)” 120″ herein), circuit boards 122A-122N, box 124, network 130, cloud-based environment 140, and external entity 160A-160N. The cloud-based environment 140 is connected to provisioning entities 110A-110D via a network 130. Although the system architecture 100 is described in the context of a cloud-based environment 140, which may enable communication between host server 142 in the cloud-based environment 140 and with provisioning entities 110A-110D over the network 130 to store and share data, it may be understood that the implementations described herein may also apply to systems that are locally interconnected. The cloud-based environment 140 may include host server 142 and data store 148. In some implementations, host servers 142 may host a supply chain security manager 144 and report generator 146.

System architecture 100 may be used by provisioning entities 110A-110D to securely provision electrical devices (e.g., semiconductor devices 120A-120N, composite device 122A-122N, box 124, etc.) during their transit along a supply chain (e.g., supply chain 170). Semiconductor devices 120A-120N may be integrated circuit devices (or other similar electronic devices) that include memory devices (e.g., memory banks) made up of memory cells that a memory controller or memory client accesses through a command interface and a data interface within the semiconductor device. The memory device may be a persistent memory module with one or more non-volatile memory (NVM) devices. Examples of semiconductor devices may include System on Chip (SoC) devices, Field Programmable Gate Array (FPGA) devices, etc. Composite devices (e.g., composite device 122A-122N and/or composite device 124) may be devices that include multiple semiconductor devices 120A-120N. For example, composite device 122A may include a circuit board that includes two or more semiconductor devices 120. Composite devices may also be devices that include multiple composite devices. For example, composite device 124 may be a circuit board, a server rack, electrical equipment, etc. that includes any combination of multiple composite devices 122A-122N and/or semiconductor devices 120A-120N. It should be understood that composite devices may be scaled up to include one or more previous composite devices (e.g., a scaled up composite device may include one or more composite devices 124, one or more composite devices 122A-122N, one or more semiconductor devices 120A-120N, etc.)

Further, system architecture 100 may provide secure transaction processing and a data reporting infrastructure designed to provide device information and asset management capabilities to provisioning entities 110A-110D and/or other computing devices, hosting systems, etc. configured to communicate with cloud-based environment 140. In some implementations, the user or customer for the system architecture 100 may include fabless semiconductor vendors, for example, that produce chipsets for mobile devices, system integrators (OEMs) that manufacture internet connected devices, or mobile network operators (MNOs) that deploy these devices on their wireless networks, etc. In some implementations, such customers may contract out some of the fabrication of their devices or components to provisioning entities 110A-110D and/or other third-party manufacturers (e.g., external entity 160A-160N) that operate remote manufacturing facilities, such as a high-volume manufacturing site.

In the manufacturing of certain devices (e.g., semiconductor devices 120A-120N, composite device 122A-122N, etc.), software, codes, keys and other important sensitive assets (e.g., secure data assets) may be embedded in or installed on the hardware devices. The management of these data assets may be important to the security and revenues of the customer. The implementations described herein provide secure-asset management systems and technologies to securely provision secure data assets, to semiconductor devices 120A-120N, using computing device cloud-based environment 140 and to verify that previous provisioning entities have securely and correctly provisioned semiconductor devices 120A-120N and to verify that unauthorized provisioning did not occur.

In some implementations, the cloud-based environment 140 refers to a collection of physical machines that include host server 142 to execute supply chain security manager 144 and report generator 146 and/or computing processes. Host server 142 providing computing functionality may provide the execution environment for supply chain security manager 144 and report generator 146. In some implementations, one or more virtual machines (VMs) may be hosted on a physical machine, such as host server 142, and each may be executed by a respective operating system. Each virtual machine may run one or more of supply chain security manager 144 and/or report generator 146. In other implementations, one or more of supply chain security manager 144 and/or report generator 146 may run directly on the hardware of host server 142.

Supply chain security manager 144 may provide provisioning entities 110A-110D with the ability to provide and receive secure device data 150. Secure device data 150 may include secure data assets, endorsements, or any other type of data used for authentication, attestation, provisioning or other cryptographic operations. Secure data assets (hereafter “data assets”) may include one or more of encrypted data (e.g., cryptographic keys), authenticated data (e.g., confirmation of the origin and/or integrity of the data), a signed certificate (e.g., a data block authenticated using an authenticating digital signature), etc. In some implementations, the data asset may include a sequence (e.g., a set of commands) or script. In some implementations, the data asset may include specialized software code.

An endorsement may include one or more measurement values that are deemed to be allowed, where measurement values may include a signature, a hash, or any other cryptographic value that represents an object (e.g., software, firmware, etc.) or state (e.g., content of a memory device, such as, for example, one-time programmable “OTP” memory). Endorsements may be used by provisioning entities 100A-110D (and/or certain users, such as customers) and compared against systems measurements to ensure that the semiconductor device 120A-120N or composite device 122A-122N, 124 is in an allowed state. Measurement data collected by the provisioning entities 100A-110D may be sent back to supply chain security manager 144 to become a new endorsement.

In some implementations, an allowed measurement is referred to as an endorsement. Each endorsement may be tied to a particular semiconductor device 120A-120N and may be associated with a specific device stage (e.g., lifecycle stage, characterization values, runtime or execution context, or the like), of the semiconductor device 120A-120N (and/or composite device) with the location of a particular semiconductor device 120A-120N along the supply chain 170. The location may refer to which provisioning entity 110A-110D is in current possession of or performing operations on, such as provisioning operations, the semiconductor device. In some implementations, one or more endorsements may be grouped into sets (referred to as endorsement sets) that create a new, authorized state of a semiconductor or composite device. As described above, a given device state may be valid at a given lifecycle state or location in supply chain 170. Endorsements and endorsement sets may be further grouped to represent authorized states of composite devices (e.g., circuit board 122A-122N, box 124, etc.), and composite device states may be further grouped to create new authorized states for more complex composite devices (e.g., composite device 124).

In some implementations, measurements may be provided by a trusted party (e.g., external entity 160A-160N) that is not involved in provisioning, or it may be collected during provisioning. Endorsements may apply to groups of devices at a given state. Endorsements may be device-specific. If a device-specific endorsement is grouped into a set, it follows that the set would also be device-specific. When that set is used as part of a composite device, the entire composite endorsement will be device specific as well.

In some implementations, secure device data 150 may be provided by one or more external entities 160. An external entity may refer to a trust entity that is not involved in provisioning operations of a particular semiconductor device. For example, prior to reaching provisioning entity 110C along supply chain 170, provisioning entities 110A and 110B may perform provisioning operations on semiconductor device 120A while external entity 160A may perform provisioning operations on semiconductor device 110B. Accordingly, provisioning entity 110C may need secure device data 150 related to the provisioning operations performed by provisioning entity 110A and/or 110B as well as by external entity 160A.

In some implementations, the secure device data 150 may be collected during provisioning operations performed by one or more provisioning entities 110A-110D. In some implementations, secure device data 150, such as endorsements, may apply to groups of semiconductor devices 120A-120N at a given device state. In some implementations, secure device data 150 may be device-specific. In some implementations, if a device-specific endorsement is grouped into a set, it follows that the set would also be device-specific. When that set is used as part of a composite device, the entire composite endorsement will be device specific as well (e.g., specific to the composite device). Secure device data 150 may be stored on data store 148.

Data store 148 may be a persistent storage that is capable of storing secure device data 150 and permissions 152. Permissions 152 may include a set of rules regarding access to a certain secure device data 150 by certain provisioning entities 110A-110D. Permissions may be stored in a data structure (e.g., a metadata table) which references which secure device data one or more provisioning entities is granted access to. The permissions may be set by, for example, user input, input received from a provisioning entity, etc. This will be discussed in detail below.

Data store 148 may be hosted by one or more storage devices, such as main memory, magnetic or optical storage-based disks, tapes or hard drives, NAS, SAN, and so forth. In some implementations, data store 148 may be a network-attached file server, while in other implementations data store 148 may be some other type of persistent storage such as an object-oriented database, a relational database, and so forth, that may be hosted by cloud-based environment 140 or one or more different machines coupled to cloud-based environment 140. In some implementations, data store 140 may be coupled to host server 142 via network 130.

Network 130 may be a public network (e.g., the Internet), a private network (e.g., a local area network (LAN) or wide area network (WAN)), or a combination thereof. Network 130 may include a wireless infrastructure, which may be provided by one or more wireless communications systems, such as a wireless fidelity (Wi-Fi) hotspot connected with the network 130 or a wireless carrier system that may be implemented using various data processing equipment, communication towers, etc. Additionally, or alternatively, network 130 may include a wired infrastructure (e.g., Ethernet).

Report generator 146 may generate an authentication report that provides aggregated provenance data. The aggregated provenance data (also referred to as lineage data) may include a recorded trail that accounts for the origin of a semiconductor device (e.g., semiconductor device 120A-120N) and/or a composite device (e.g., composite device 122A-122N, 124) and where the semiconductor device or the composite device has moved from (along supply chain 170) to where it is presently (e.g., a customer). In some implementations, the authentication report may include a listing of the secure device data 150 provided by each provisioning entity 110A-110D along supply chain 170, a listing of verification and/or attestation operations performed on a respective semiconductor device and/or composite device, etc. the authentication report may be used by a user (e.g., customer) to verify that all of the provisioning entities have provisioned the each semiconductor device and/or each composite device correctly and that no additional provisioning has taken place.

Provisioning entity 110A-110D may include one or more entities (e.g., facilities, manufacturers, companies, suppliers, vendors, users, organizations, etc.) capable of provision a semiconductor device 120. In some implementations, provisioning entity 110A-110D may be a system or sub-system. In an illustrative example, provisioning entity 110A may include a semiconductor device manufacturer and provisioning entity 110C-110D may include facilities configured to provision the semiconductor devices manufactured by provisioning entity 110A. Each provisioning entity 110A-110D may include one or more provisioning devices 112A-112D. A provisioning device 112A-112D may be any computer or other device that communicates with semiconductor device 120A-120N to create and/or set up an information technology infrastructure and/or perform operations required to manage user and system access to various resources, such as, for example, data assets. In some implementations, a provisioning device may include at least one memory device to store the data assets. In some implementations, a provisioning device includes a monolithic integrated circuit. In some implementations, each provisioning device may include one or more of a provisioning application(s), a cryptographic hash engine(s), a signing engine(s), a nonce generator, a random number generator, and/or or other component configured to provide provisioning services. A provisioning application may refer to software configured to perform one or more functions or procedures related to provisioning a security context on a semiconductor device, such as on semiconductors device 120A-120N. A cryptographic hash engine may cryptographically hash values. In particular, a cryptographic hash engine may apply a hashing function, perform one or more cryptographic hashes, etc. over one or more values to generate a hash digest. In some implementations, cryptographic hash engine may apply the hashing function over one or more of a concatenation of a security context, a nonce, a public key, a private key, etc. A signing engine may generate a cryptographic output (e.g., cryptographic signature) that may later be used to verify the integrity and authenticity of data. In particular, a signing engine may sign data, such as a hash digest, using a cryptographic key (e.g., a private key, a pre-shared key, etc.). A signing engine may include a Message Authentication Codes (MAC) engine, or any other type of signing engine. The signing engine may perform a signing operation and a verification operation. The signing operation uses a cryptographic key to generate a cryptographic signature over raw data. The verification operation may validate signed data using the same or a different cryptographic key. For example, data may be signed using a private key of a public-private key pair and the signed data may be verified using the public key of the key pair. A nonce generator may generate a nonce (e.g., a nonce value). The nonce value may be an arbitrary value used just once in a cryptographic communication or operation. In some implementations, the nonce value may be a concatenation of one or more of parameters, such as an initialization vector (IV), the memory address referencing a location of the user data, a counter value, a random number, etc. In some implementations, the nonce may be a random number obtained from a random number generator. A random number generator may be a hardware random number generator (HRNG) or true random number generator (TRNG) that generates random numbers from a physical process (rather than by means of an algorithm). Provisioning devices 112A-112D may communicate via a wireless (e.g., a wireless network) or wired connection.

As discussed above, semiconductor devices 120A-120N may be integrated circuit devices or other similar electronic devices. In some implementations, semiconductor device 120A-120N may include one or more processors (e.g., a central processing unit (CPU), or the like), an interface (IF) controller, a memory device, non-volatile memory (NVM) storage device, etc. Interface circuitry, such as the interface controller, may be configured to receive messages from an external system (e.g., a provisioning device 112A-112D) over a communications link. The processor may process requests from the provisioning entity 110A-110D, from host server 142, etc. The processor may perform cryptographic functions. In some implementations, a primary processor is responsible for overall control of the semiconductor device 120A-120N while a secure processor operates on behalf of the primary processor to perform the cryptographic functions. The memory device may refer to computer memory that requires power to maintain the stored information (e.g., random-access memory (RAM), dynamic random-access memory (DRAM), synchronous DRAM (SDRAM), static memory (e.g., static random-access memory (SRAM)) etc.) Non-volatile storage device may be any type of computer memory that may retain stored information even after power is removed, such as flash memory (e.g., NAND flash, solid-state drives (SSD), etc.), read-only memory (ROM), EPROM (erasable programmable ROM), EEPROM (electrically erasable programmable ROM), hard disk drives, optical drives, etc.

In some implementations, semiconductor device 120A-120N may include one-time programmable (OTP) memory. The OTP memory may be a type of digital memory implemented in circuitry or silicon of semiconductor device 120A-120N that may be programmed and cannot be changed after being programmed. For example, security context data and/or data assets may be programmed onto the OTP memory and the data cannot be changed in the OTP memory after the programming. The OTP memory may be a type of digital memory where the setting of each bit of the OTP memory is locked by a fuse (e.g., an electrical fuse associated with a low resistance and designed to be permanently break an electrically conductive path after the programming or setting of a corresponding bit) or an antifuse (e.g., an electrical component associated with an initial high resistance and designed to permanently create an electrically conductive path after the programming or setting of a corresponding bit). As an example, each bit of the OTP memory may start with an initial value of ‘0’ and may be programmed or set to a later value of ‘1’ (or vice versa). Thus, in order to program or set a device specific key or a unique device identification (ID) with a value of ‘10001’ into the OTP memory, two bits of the OTP memory may be programmed from the initial value of ‘0’ to the later value of ‘1.’ Once the two bits of the OTP memory have been programmed to the later value of ‘1’, then the two bits may not be programmed back to the value of ‘0.’ As such, the bits of the OTP memory may be programmed once and may not be changed once programmed.

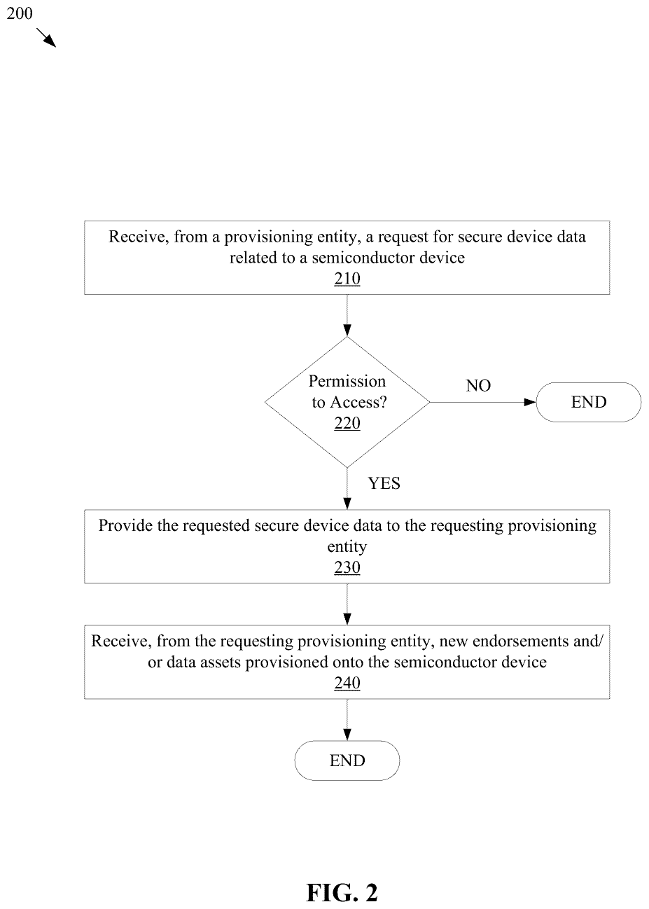

FIG. 2 depicts a flow diagram of an example method 200 for collecting and providing secure device data to provisioning entities, in accordance with some implementations of the disclosure. The individual functions, routines, subroutines, or operations of method 200 may be performed by a processing device, having one or more processing units (CPU) and memory devices communicatively coupled to the CPU(s). In some implementations, method 200 may be performed by a single processing thread or alternatively by two or more processing threads, each thread executing one or more individual functions, routines, subroutines, or operations of the method. Method 200 as described below may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 200 may be performed by host server 142 as described in FIG. 1. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible. In some implementations, the same, different, fewer, or greater operations may be performed. It is noted that elements of FIG. 1 may be used herein to help describe FIG. 2.

At operation 210 of method 200, processing logic receives, from a provisioning entity, a request for secure device data related to a semiconductor device. The secure device data requested may be data generated and/or provisioned on the semiconductor device by a previous provisioning entity or a manufacturer. For example, the requested secure device data may include one or more data assets (e.g., a cryptographic key, a certificate, etc.) and/or one or more endorsements.

At operation 220, processing logic determines whether the requesting provisioning entity has permission to access to the requested secure device data. In some implementations, the processing logic may perform a lookup of a data structure (e.g., a metadata table of permissions 152) to determine whether the requesting provisioning entity has access to the requested secure device data.

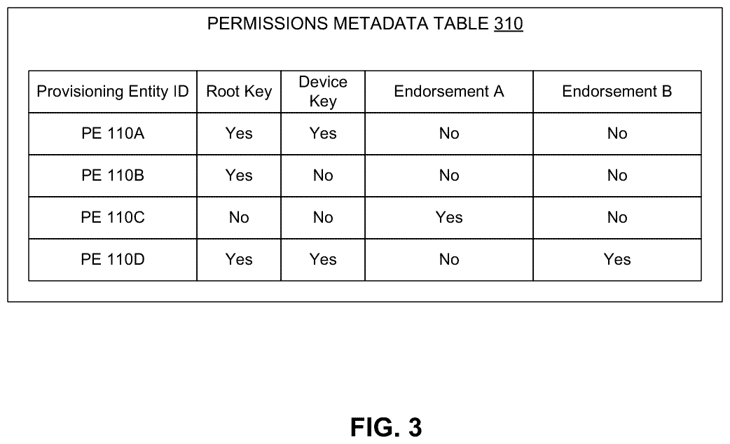

FIG. 3 schematically illustrates example permissions 152 metadata maintained by supply chain security manager 144 and stored on data store 148, in accordance with some implementations of the present disclosure. In particular, supply chain security manager 144 may maintain a permissions metadata table 310 that includes each provisioning entity 110A-110D along with an indicator indicative of whether the provisioning entity is granted access to certain secure device data and/or restricted from accessing certain secure device data. The indicator may be metadata maintained in a data structure where a flag (e.g., a bit set to a value of 1 to indicate that a particular provisioning entity is allowed access to a particular secure device data and set to a value of 0 to indicate that the provisioning entity is denied access to certain secure device data, or vice-versa). In some implementations, the permissions may be global permissions, (e.g., permissions that are the same for all semiconductor devices and/or composite devices), permissions applicable to a subset of devices (e.g., one or more particular semiconductor and/or composite devices), or any combination thereof.

As illustrated in FIG. 3, permissions metadata table 310, by way of exemplary example, maintains entries that that correlate each provisioning entity 110A-110D with root key access values, device key access values, endorsement A access values, and endorsement B access values. The root key access values may indicate whether a particular provisioning entity is allowed access to the root key stored on a semiconductor device. The device key access values may indicate whether a particular provisioning entity is allowed access to the device key stored on the semiconductor device. The endorsement A access values may indicate whether a particular provisioning entity is allowed access to a particular endorsement stored on the semiconductor device. The endorsement B access values may indicate whether a particular provisioning entity is allowed access to another particular endorsement stored on the semiconductor device. For example, provisioning entities 110A-110D are listed. Provisioning entity 110A is allowed access to the root key and the device key, but not to endorsements A and B. Provisioning entity 110B is allowed access to the root key, but not to the device key or to endorsements A and B. Provisioning entity 110C is allowed access to endorsements A, but not to the root key, the device key, or to endorsement B. Provisioning entity 110D is allowed access to the root key, the device key, and to endorsement B, but not to endorsement A. In some implementations, a permissions metadata table may identify provisioning entities 110A-110D that are allowed to access certain secure device data (e.g., a whitelist) or which provisioning entities 110A-110D are restricted from accessing certain secure device data (e.g., a blacklist).

Returning to FIG. 2, based on determining that the requesting provisioning entity does not have permission to access the requested secure device data, the processing logic may deny the request and end method 200. Based on determining that requesting provisioning entity has permission to access the requested secure device data, the processing logic may proceed to operation 230.

At operation 230, the processing logic provides the requested secure device data to the requesting provisioning entity. The requesting provisioning entity may then perform authentication and/or attestation operations, using the received secure device data, to verify the authenticity and/or state of the semiconductor device. In some implementations, once verified, the requesting provisioning entity may then provision certain data assets onto the semiconductor device. For example, the requesting provisioning entity may add cryptographic keys to the OTP, install firmware on the non-volatile memory, install configuration data on a processor, etc. The requesting provisioning entity may then generate one or more new endorsements based on the, for example, provisioned data assets. For example, the requesting provisioning entity may determine a measurement value (e.g., a hash value, a signature, etc.) of the OTP state, the non-volatile memory state, a processor state, etc.

At operation 240, the processing logic receives, from the requesting provisioning entity, the new endorsements and/or the data associated with the data assets provisioned onto the semiconductor device. The processing logic may store this data in a data store (e.g., data store 148) as secure device data. The new secure device data (and/or secure device data generated by other provisioning entities) may then be requested by one or more subsequent provisioning entities, pending having permission to access the secure device data. The processing logic may then end method 200.

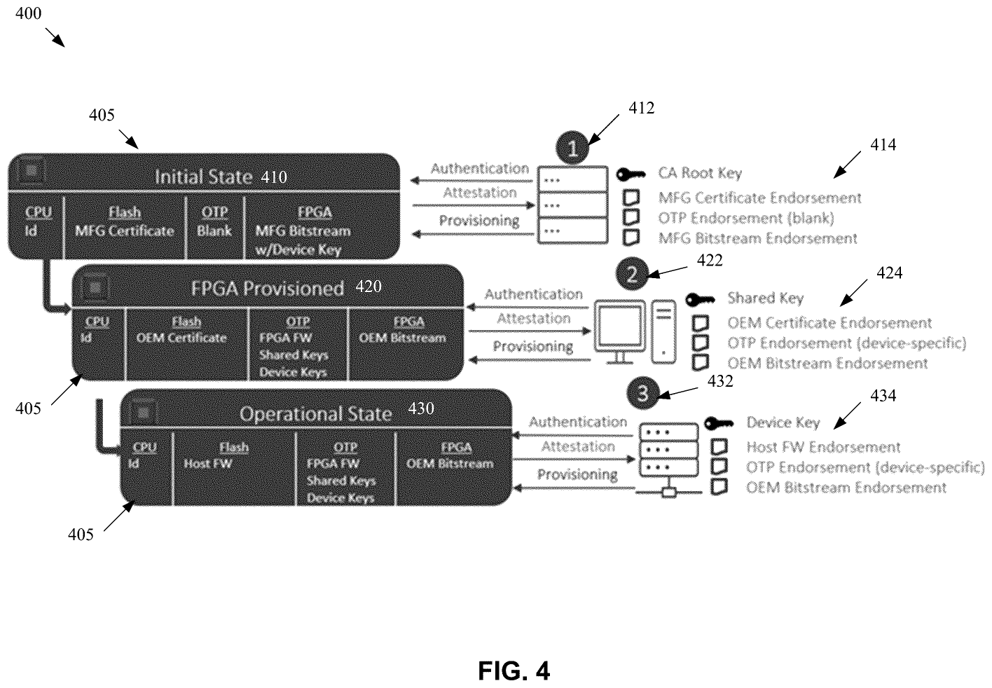

FIG. 4 is a diagram 400 illustrating an example of secure device data being managed along a supply chain, in accordance with some implementations of the disclosure. In particular, diagram 400 depicts a semiconductor device 405 transiting through three provisioning entities 412, 422, 432. Semiconductor device 405 include a CPU, flash memory (e.g., non-volatile memory), OTP memory, and an FPGA IC. Initial state 400 may be indicative of semiconductor device 405 in an initial state 410. The initial state may reflect a post-manufacturing state. In some implementations, the data initially programmed to semiconductor device 405 (e.g., a manufacturer's certificate, a manufacturer's bitstream, and a device key) may be sent to supply chain security manager 144. Provisioning server 412 may receive semiconductor device 405 (e.g., from the manufacturer), request the corresponding secure device data 414 from supply chain security manager 144, and perform authentication and attestation operations. Secure device data 414 may include a public root key, a manufacturer's certificate endorsement, an OTP endorsement, and a manufacturer's bitstream endorsement. Provision entity 412 may then use the public root key to perform authentication operations by authenticating semiconductor device 405. Provision entity 412 may then use the manufacturer's certificate endorsement, the OTP endorsement, and the manufacturer's bitstream endorsement to perform attestation operations by verify the state of the flash memory, the OTP memory and the FPGA IC. Responsive to the attestation operations verifying the states of the substrate device 405, provisioning entity 412 may perform provisioning operations on semiconductor device 405. Provisioning entity 412 may then generate endorsements of the flash memory, the OTP memory, and the FPGA IC (in their new state) and send the endorsements to supply chain security manager 144. Provisioning entity 412 may also send any data assets provisioned onto semiconductor device 405 to supply chain security manager 144. Semiconductor device 405 (now in the FPGA provisioned state 420) may then move along the supply chain to provisioning entity 420, which may also perform authentication operations and attestation operations using secure device data 424 received from supply chain security manager 144. Provisioning entity 424 may then perform provisioning operations and send new secure device data to supply chain security manager 144.

Semiconductor device 405 (now in the operational state 430) may then move along the supply chain to provisioning entity 430, which may also perform authentication operations and attestation operations using secure device data 434 received from supply chain security manager 144. Provisioning entity 434 may then perform provisioning operations and send new secure device data to supply chain security manager 144.

As discussed above, the supply chain security manager 144 collects device information (e.g., secure device data) across a supply chain and report generator 146 may provide aggregated provenance data, including device state and evidence of activities against the device (provisioning, test, infrastructure authentication, device authentication, etc.), as evidence that a composite device has been processed by an approved supply chain in an approved manner.

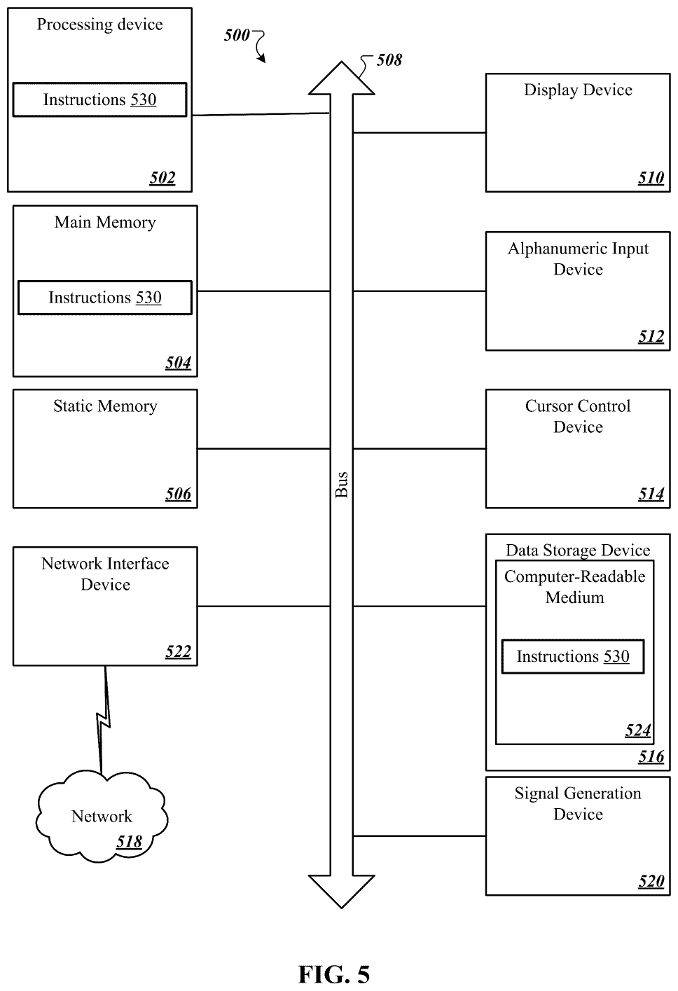

FIG. 5 is a block diagram illustrating an exemplary computer system 500, in accordance with some implementations of the disclosure. The computer system 500 executes one or more sets of instructions 530 that cause the machine to perform any one or more of the methodologies discussed herein. Set of instructions, instructions, and the like may refer to instructions that, when executed by computer system 500, cause computer system 500 to perform one or more operations of host server 142. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 530 of the computer system 100 for performing the operations discussed herein.

The computer system 500 may further include a network interface device 522 that provides communication with other machines over a network 518, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a non-transitory computer-readable storage medium 524 on which is stored the sets of instructions of the computer system 100 embodying any one or more of the methodologies or functions described herein. The sets of instructions 530 may also reside, completely or at least partially, within the main memory 504 and/or within the processing device 502 during execution thereof by the computer system 500, the main memory 504 and the processing device 502 also constituting computer-readable storage media. The sets of instructions 530 may further be transmitted or received over the network 518 via the network interface device 522.

While the example of the computer-readable storage medium 524 is shown as a single medium, the term “computer-readable storage medium” may include a single medium or multiple media (e.g., a centralized or distributed database, and/or associated caches and servers) that store the sets of instructions 530. The term “computer-readable storage medium” may include any medium that is capable of storing, encoding or carrying a set of instructions 530 for execution by the machine and that cause the machine to perform any one or more of the methodologies of the disclosure. The term “computer-readable storage medium” may include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions 530.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above-described implementations are disclosed. Additionally, in implementations of the disclosure, a non-transitory computer-readable storage medium stores instructions 530 for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
receiving, from a first provisioning entity, a request for first secure device data related to a semiconductor device, wherein the first secure device data is associated with one or more provisioning operations performed, on the semiconductor device, by a second provisioning entity;
determining whether the first provisioning entity has permission to access the first secure device data;
based on determining that the first provisioning entity has permission to access the first secure device data, providing to the first provisioning entity the first secure device data; and
receiving, from the first provisioning entity, second secure device data associated with one or more provisioning operations performed by the first provisioning entity on the semiconductor device.

2. The method of claim 1, wherein the first secure device data comprises at least one measurement value that represents an object or state of the semiconductor device, or a secure data asset.

3. The method of claim 1, further comprising:
generating an authentication report comprising a recorded trail of the first secure device data and the second secure device data.

4. The method of claim 3, wherein the authentication report further comprises third secure device data associated with a composite device, wherein the composite device comprises the semiconductor device and at least one other semiconductor device.

5. The method of claim 1, further comprising:
maintaining, in a data structure, metadata indicative of access permissions for particular secure device data with respect to each provisioning entity of a plurality of provisioning entities.

6. The method of claim 1, wherein the first provisioning entity and the second provisioning entity are each operations along a supply chain associated with producing a composite device comprising the semiconductor device and at least one other semiconductor device.

7. The method of claim 1, wherein the first secure device data and the second secure device data are stored in a cloud-based environment.

8. The method of claim 1, wherein the first secure data is used by the first provisioning entity or by one or more subsequent provisioning entities to perform at least one of an authentication operation or an attestation operation to verify authenticity of the semiconductor device.

9. A system, comprising:
a memory device; and
a processing device, coupled to the memory device, to perform operations comprising:
receiving, from a first provisioning entity, a request for first secure device data related to a semiconductor device, wherein the first secure device data is associated with one or more provisioning operations performed, on the semiconductor device, by a second provisioning entity;
determining whether the first provisioning entity has permission to access the first secure device data;
based on determining that the first provisioning entity has permission to access the first secure device data, providing to the first provisioning entity the first secure device data; and
receiving, from the first provisioning entity, second secure device data associated with one or more provisioning operations performed by the first provisioning entity on the semiconductor device.

10. The system of claim 9, wherein the first secure device data comprises at least one measurement value that represents an object or state of the semiconductor device, or a secure data asset.

11. The system of claim 9, wherein the operations further comprise:
generating an authentication report comprising a recorded trail of the first secure device data and the second secure device data.

12. The system of claim 11, wherein the authentication report further comprises third secure device data associated with a composite device, wherein the composite device comprises the semiconductor device and at least one other semiconductor device.

13. The system of claim 9, wherein the operations further comprise:
maintaining metadata, in the data structure, indicative of access permissions for particular secure device data with respect to each provisioning entity of a plurality of provisioning entities.

14. The system of claim 9, wherein the first provisioning entity and the second provisioning entity are each operations along a supply chain associated with producing a composite device comprising the semiconductor device and at least one other semiconductor device.

15. The system of claim 9, wherein the first secure device data and the second secure device data are stored in a cloud-based environment.

16. The system of claim 9, wherein the first secure data is used by the first provisioning entity or by one or more subsequent provisioning entities to perform at least one of an authentication operation or an attestation operation to verify the authenticity of the semiconductor device.

17. A non-transitory computer-readable medium comprising instructions that, based on execution by a processing device, cause the processing device to perform operations comprising:
receiving, from a first provisioning entity, a request for first secure device data related to a semiconductor device, wherein the first secure device data is associated with one or more provisioning operations performed, on the semiconductor device, by a second provisioning entity;
determining whether the first provisioning entity has permission to access the first secure device data;
based on determining that the first provisioning entity has permission to access the first secure device data, providing to the first provisioning entity the first secure device data; and
receiving, from the first provisioning entity, second secure device data associated with one or more provisioning operations performed by the first provisioning entity on the semiconductor device.

18. The non-transitory computer-readable medium of claim 17, wherein the first secure device data comprises at least one measurement value that represents an object or state of the semiconductor device, or a secure data asset.

19. The non-transitory computer-readable medium of claim 17, wherein the operations further comprise:
generating an authentication report comprising a recorded trail of the first secure device data and the second secure device data.

20. The non-transitory computer-readable medium of claim 17, wherein the operations further comprise:
maintaining metadata, in the data structure, indicative of access permissions for particular secure device data with respect to each provisioning entity of a plurality of provisioning entities.
